(19) United States
(12) Patent Application Publication
(10) Pub. No.: US 2007/0050707 A1
(43) Pub. Date: Mar. 1, 2007

(54) ENABLEMENT OF MULTIPLE SCHEMA MANAGEMENT AND VERSIONING FOR APPLICATION-SPECIFIC XML PARSERS

(76) Inventors: Erxiang Liu, Austin, TX (US); Ningning Wang, Round Rock, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/277,974

(22) Filed: Mar. 30, 2006

Related U.S. Application Data
(63) Continuation-in-part of application No. 11/214,566, filed on Aug. 30, 2005.

(51) Int. Cl. G06F 17/00

(52) U.S. Cl. 715/513

(57) ABSTRACT

A method of XML file processing is provided. The method may include creating a schema repository for storing more than one version of an XML schema. One of the more than one version of the XML schema may be retrieved from the schema repository. The method may also include receiving the one of the more than one version of the XML schema and a set of semantic actions by a version-sensitive parser generation engine. A XML version-sensitive parser may be generated by the version-specific parser generation engine.

### CROSS-REFERENCE TO RELATED APPLICATIONS

The present application is a continuation-in-part under 35 U.S.C. § 120 of U.S. application Ser. No. 11/214,566, entitled “XML COMPILER THAT WILL GENERATE AN APPLICATION-SPECIFIC XML PARSER,” filed on Aug. 30, 2005. The present application is related to the following co-pending United States patent applications: United States patent application entitled “METHOD OF XML TRANSFORMATION AND PRESENTATION UTILIZING AN APPLICATION-SPECIFIC PARSER,” Docket No. AUS920050753US1; United States patent application entitled “GENERATION OF APPLICATION-SPECIFIC XML PARSERS USING JAR FILES WITH PACKAGE PATHS THAT MATCH THE XML XPATHS,” Docket No. AUS920050756US1; and United States patent application entitled “METHOD OF XML ELEMENT LEVEL COMPARISON AND ASSERTION UTILIZING AN APPLICATION-SPECIFIC PARSER,” Docket No. AUS920050757US1. All of the aforementioned applications are hereby incorporated by reference in their entireties.

### FIELD OF INVENTION

The present invention generally relates to the field of software, and more particularly to a method of XML file processing.

### BACKGROUND OF THE INVENTION

Extensible Markup Language (XML) is a widely accepted standard for describing data. XML is a standard that allows an author/programmer and the like to describe and define data (e.g., type and structure) as part of the XML content/document. Since XML content may describe data, any application that understands XML regardless of the applications programming language and platform has the ability to process the XML based content.

An XML parser is a software program that reads XML files and makes the information from those files available to applications and programming languages, usually through a known interface. The XML content may optionally reference another document or set of rules that define the structure of an XML document/content. This other document or set of rules is often referred to as a schema. When an XML document references a schema, some parsers may check for validity in which the parser determines if the document follows the rules schema.

The Extensible Markup Language (XML) has become the industry standard for exchanging data across systems because of the language's flexibility and consistent syntax. However, conventional XML parsing (e.g., parsing by use of a general-purpose external parser) is slow in many applications. General-purpose parsers process XML content into general-purpose data structures, then apply run-time analysis to rebind the data to application-specific structures. Extra space is consumed by intermediate data structures (e.g., general purpose data structures) and extra time may be spent creating and analyzing them. Moreover, it is labor intensive to write the conversion code that converts the general-purpose data structures to application-specific data structures required for final processing.

In order to transform one XML document into another, a language known as eXtensible Stylesheet Language: Transformations (XSLT) is often employed. Current XSLT implementations rely on a generic (Document Object Model—DOM) parser to convert the XML document to a tree structure that may be manipulated by applications before it may be transformed into a desired format. Such process is slow and resource consuming. While developers may write an application-specific transformation engine by hand, such process is very labor-intensive. Further, while an application-specific engine may function well in an environment where XML schemas are relatively stable, such are limited in a highly dynamic environment for changes in XML vocabulary often result in a mismatch between generated parsers from the old schemas and target XML files that conform to the new schemas.

Therefore, it would be desirable to provide a method which allowed multiple schemas to be managed by application-specific XML parsers.

### SUMMARY OF THE INVENTION

In a first aspect of the invention, a method of XML file processing is provided. The method may include creating a schema repository for storing more than one version of an XML schema. One of the more than one version of the XML schema may be retrieved from the schema repository. The method may also include receiving the one of the more than one version of the XML schema and a set of semantic actions by a version-sensitive parser generation engine. A XML version-sensitive parser may be generated by the version-specific parser generation engine.

In a further aspect of the present invention, a computer program product including a computer useable medium with computer usable program code for creating a method for XML file processing is disclosed. The computer program product may include computer usable program code for creating a schema repository for storing more than one version of an XML schema. Computer usable program code for retrieving one of the more than one version of the XML schema from the schema repository may also be included. In addition, the computer program product may also include computer usable program code for receiving the one of the more than one version of the XML schema and a set of semantic actions by a version-sensitive parser generation engine. Finally, computer usable program code for generating a XML version-sensitive parser by the version-sensitive parser generation engine may also be present within the computer program product.

In an additional aspect of the present invention, an additional method of XML file processing is provided which may include generating a schema repository for storing more than one version of an XML schema. In the present aspect, each of the more than one version of an XML schema includes a namespace uniform resource identifier (URI). The method may also include comparing an incoming XML schema namespace with each of the namespace uniform resource identifiers of the more than one version of an XML schema stored in the schema repository. If the incoming XML schema namespace matches the namespace URI of one of the more than one version of the XML schema, a version-sensitive XML schema may be rendered which corresponds to the incoming XML schema namespace. The rendered version-sensitive XML schema and a set of semantic actions may be received by a version-sensitive parser generation engine to generate a version-sensitive parser.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method of XML file processing in accordance with an exemplary embodiment of the present invention;

FIG. 2 is block diagram illustrating a system for XML file processing in accordance with an exemplary embodiment of the present invention; and

FIG. 3 is a flow diagram illustrating an additional method of XML file processing in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

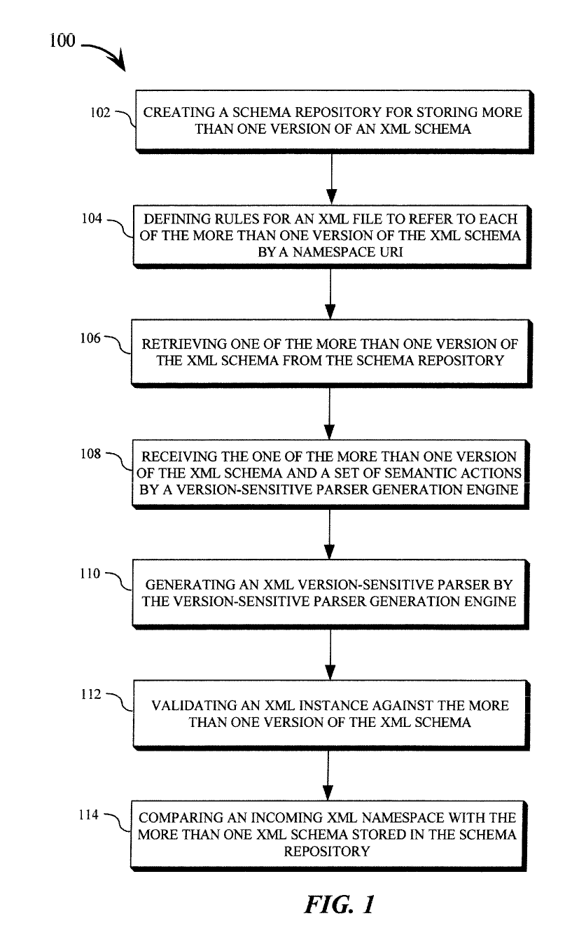

Referring to FIG. 1, a method 100 of XML file processing is provided. In an exemplary embodiment, the method 100 may include creating a schema repository for storing more than one version of an XML schema 102. In an embodiment, an XML schema includes several XML schema documents. In the present embodiment, multiple versions of multiple schemas may be stored in the schema repository.

The method 100 may also include defining rules for an XML file to refer to each of the more than one version of the XML schema by a namespace URI 104. A URI is a uniform resource identifier which is a sequence of characters with a restricted syntax that may act as a reference to something that has identity. For example, the URI provides identity to a resource. In an embodiment, each of the more than one version of the XML schema is stored in the schema repository with a namespace name. In a further embodiment, each namespace name is expressed as a URI. Moreover, the rules may be defined for the XML files to refer to a version specific schema by its URI with the default as the “current version” of the XML schema. An example may be xmlns=“http://www.ibm.com/eg/schemas/foo/1.0”.

In further exemplary embodiments, the method 100 may include retrieving one of the more than one version of the XML schema from the schema repository 106. For instance, the one of the more than one version of the XML schema may be retrieved from the schema repository based on the URI. In an embodiment, a hash-table like mechanism may be used to retrieve XML schemas based on the provided

In additional exemplary embodiments, the method 100 may include receiving the one of the more than one version of the XML schema and a set of semantic actions by a version-sensitive parser generation engine 108. The method 100 may also include generating an XML version-sensitive parser by the version-sensitive parser generation engine 110. For example, at runtime, the desired version of an XML schema is retrieved from the schema repository based on the instance's namespace and the version-sensitive parser generation engine generates the version-sensitive parser. In an embodiment, the version-specific parser includes an index of the more than one version of the XML schema stored in the schema repository. For instance, each of the more than one version of the XML schema stored in the schema repository is indexed in the version-specific parser by each of the respective URI's. In a preferred embodiment, compiler technology is used to automatically generate the version-sensitive parser.

In other exemplary embodiments, the method 100 may include validating an XML instance against the more than one version of the XML schema 112. In an embodiment, an XML instance is an XML document that is a candidate to be validated by an XML schema. The method 100 may also include comparing an incoming XML namespace with the more than one XML schema stored in the schema repository 114.

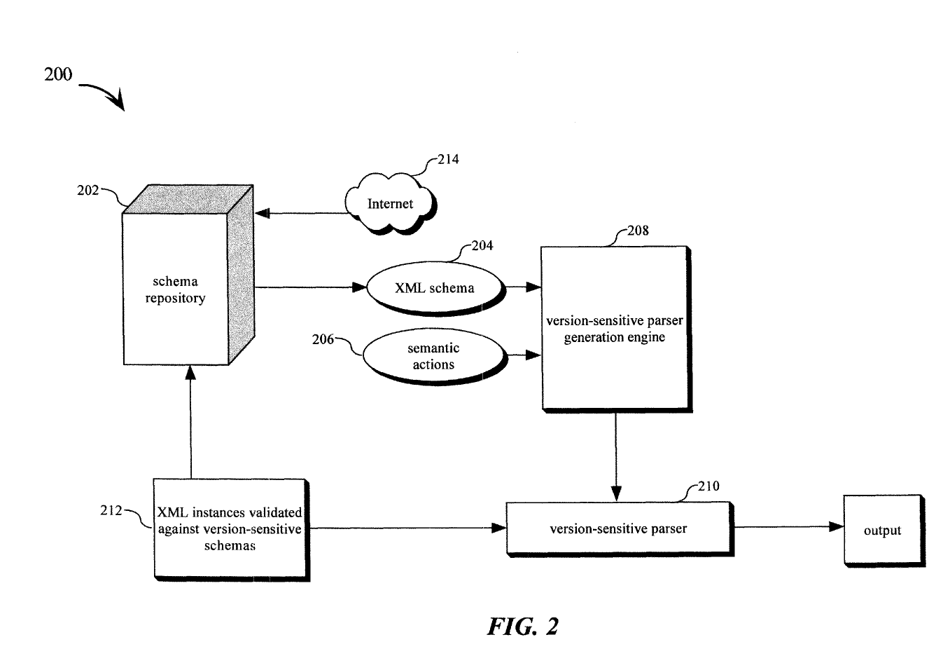

Referring to FIG. 2, a system 200 for XML file processing in accordance with an exemplary embodiment of the present invention is provided in which the system 200 is configured to handle multiple versions of multiple XML schemas. In an exemplary embodiment, the system 200 includes a schema repository 202 for storing a XML schema 204. In an embodiment, the schema repository 202 stores multiple versions of multiple XML schemas. Each version of an XML schema 204 may be stored in the schema repository 202 with a URI. An XML schema 204 and a set of semantic actions 206 may be utilized to generate a version-sensitive parser generation engine 208. The version-sensitive parser generation engine 208, in turn, generates a version-sensitive parser 210. In an additional embodiment, the version-sensitive parser generation engine 208 generates the version-sensitive parser 210 by compiler technology.

In a further exemplary embodiment, XML instances may be validated against version-sensitive schemas 212 in which the version-sensitive schemas are stored in the schema repository 202. For example, at runtime, the system 200 analyzes an incoming XML schema (e.g., the XML's namespace) and if the namespace corresponds to an existing schema's URI in the schema repository 202, such version of the schema is rendered. If the namespace does not correspond to an existing schema's URI then a new schema is retrieved from the Internet 214, versioned and then, added to the schema repository 202.

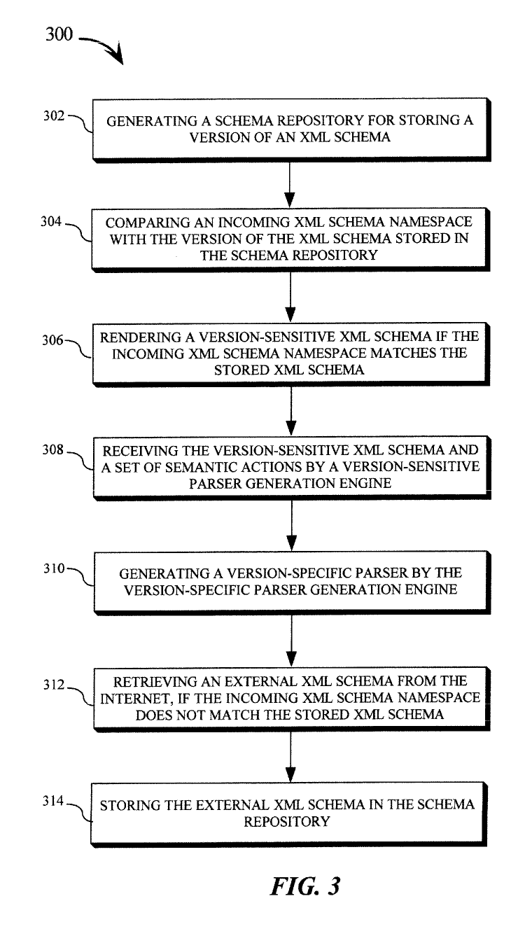

Referring to FIG. 3, an additional method of XML file processing is provided. In an exemplary embodiment, the method 300 of XML file processing includes generating a schema repository for storing more than one version of an XML schema 302. In the present embodiment, each of the more than one version of an XML schema includes a namespace URI. The method 300 may also include comparing an incoming XML schema namespace with each of the namespace uniform resource identifiers of the more than one version of an XML schema stored in the schema repository 304. If the incoming XML schema namespace matches the namespace URI of one of the more than one version of the XML schema, a version-sensitive XML schema may be rendered which corresponds to the incoming XML schema namespace 306. The method 300 may also include receiving the version-sensitive XML schema and a set of semantic actions by a version-sensitive parser generation engine 308. In turn, the method 300 may include generating a version-sensitive parser by the version-sensitive parser generation engine 310. In an embodiment, the version-sensitive parser is indexed with each of the more than one version of the XML schema's URI stored in the schema repository. In an additional embodiment, the version-sensitive parser generation engine generates the version-sensitive parser by compiler technology.

In further exemplary embodiments, the method 300 may include retrieving an external XML schema from the Internet, if the incoming XML schema namespace does not match the stored XML schema 312. In an embodiment, an external XML schema includes a schema obtained from a source separate from the schema repository. The external XML schema may be assigned a version such as a namespace URI. In the present embodiment, the method 300 may include storing the external XML schema (e.g., the versioned external XML schema) in the schema repository 314 so that it may be accessed at a later time.

It is to be understood that the disclosed invention may be employed in a number of systems including embedded systems such as a Service Management Framework (SMF). Further, the present invention may be utilized by consulting services such as WebSphere Commerce (WCS) and WebSphere Business Integration (WBI). In addition, the invention may be used in performance critical applications such as SMF and web services. Moreover, the instant invention may be incorporated as a plug-in into an Integrated Development Environment (IDE) such as WebSphere Studio Application Developer (WSAD), Eclipse, and the like.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become couple to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages is to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of Extensible Markup Language (XML) file processing, comprising steps of:
creating a schema repository for storing more than one version of an XML schema;
retrieving one of the more than one version of the XML schema from the schema repository;
receiving by a version-sensitive parser generation engine the one of the more than one version of the XML schema and a set of semantic actions; and
generating a XML version-sensitive parser by the version-specific parser generation engine.

2. The method as claimed in claim 1, wherein each of the more than one version of the XML schema is stored with a namespace name.

3. The method as claimed in claim 2, wherein each namespace name is expressed as a uniform resource identifier (URI).

4. The method as claimed in claim 3, wherein the one of the more than one version of the XML schema is retrieved from the schema repository based on the URI.

5. The method as claimed in claim 1, further comprising the step of defining rules for an XML file to refer to each of the more than one version of the XML schema by a namespace uniform resource identifiers (URI).

6. The method as claimed in claim 1, further comprising the step of validating an XML instance against the more than one version of the XML schema.

7. The method as claimed in claim 1, further comprising the step of comparing an incoming XML namespace with the more than one version of the XML schema stored in the schema repository.

8. The method as claimed in claim 1, wherein the version-specific parser includes an index of the more than one version of the XML schema stored in the schema repository.

9. A computer program product, comprising:
a computer useable medium including computer usable program code for creating a method for Extensible Markup Language (XML) file processing, the computer program product including:
computer usable program code for creating a schema repository for storing more than one version of an XML schema;
computer usable program code for retrieving one of the more than one version of the XML schema from the schema repository;
computer usable program code for receiving by a version-sensitive parser generation engine the one of the more than one version of the XML schema and a set of semantic actions; and
computer usable program code for generating a XML version-sensitive parser by the version-sensitive parser generation engine.

10. The computer program product as claimed in claim 9, wherein each of the more than one version of the XML schema is stored with a namespace name.

11. The computer program product as claimed in claim 10, wherein each namespace name is expressed as a uniform resource identifier (URI).

12. The computer program product as claimed in claim 11, wherein the one of the more than one version of the XML schema is retrieved from the schema repository based on the URI.

13. The computer program product as claimed in claim 9, wherein the computer program product further comprises computer usable program code for defining rules for an XML file to refer to each of the more than one version of the XML schema by a namespace uniform resource identifiers (URI).

14. The computer program product as claimed in claim 9, wherein the computer program product further comprises computer usable program code for validating an XML instance against the more than one version of the XML schema.

15. The computer program product as claimed in claim 9, wherein the computer program product further comprises computer usable program code for comparing an incoming XML namespace with the more than one XML schema stored in the schema repository.

16. A method of Extensible Markup Language (XML) file processing, comprising the steps of:
generating a schema repository for storing more than one version of an XML schema, each of the more than one version of an XML schema including a namespace uniform resource identifier (URI);
comparing an incoming XML schema namespace with each of the namespace uniform resource identifiers of the more than one version of an XML schema stored in the schema repository;
when the incoming XML schema namespace matches the namespace URI of one of the more than one version of the XML schema, rendering a version-sensitive XML schema which corresponds to the incoming XML schema namespace; and
receiving by a version-sensitive parser generation engine the version-sensitive XML schema and a set of semantic actions to generate a version-sensitive parser.

17. The method as claimed in claim 16, wherein the version-sensitive parser is indexed with each of the more than one version of the XML schema's URI stored in the schema repository.

18. The method as claimed in claim 16, further comprising a step of retrieving an external XML schema from the Internet, if the incoming XML schema namespace does not match the namespace uniform identifier resource of one of the more than one version of the XML schema stored in the schema repository.

19. The method as claimed in claim 18, further comprising storing the external XML schema in the schema repository.

20. The method as claimed in claim 16, wherein the version-sensitive parser generation engine generates the version-sensitive parser by a compiler.
